(19) United States
(12) Patent Application Publication
(10) Pub. No.: US 2026/0185481 A1
(43) Pub. Date: Jul. 2, 2026

(54) ROTATING DETONATION TURBINE INTERBURNER

(71) Applicant: RTX Corporation, Farmington, CT (US)

(72) Inventor: Steven W. Burd, Cheshire, CT (US)

(73) Assignee: RTX Corporation, Farmington, CT (US)

(21) Appl. No.: 19/546,059

(22) Filed: Feb. 20, 2026

Related U.S. Application Data
(63) Continuation of application No. 17/744,542, filed on May 13, 2022.
(60) Provisional application No. 63/197,240, filed on Jun. 4, 2021.

(51) Int. Cl. F02C 7/00; G01S 17/66

(52) U.S. Cl. CPC F02C 7/00; G01S 17/66

(57) ABSTRACT

An assembly for a gas turbine engine includes a primary combustor disposed within a core flow path of the gas turbine engine; a high-pressure turbine positioned downstream of the primary combustor; a low-pressure turbine positioned downstream of the high-pressure turbine; and a supplemental combustor positioned within the core flow path, downstream of the high-pressure turbine and upstream of the low-pressure turbine.

### CROSS-REFERENCE TO RELATED APPLICATIONS

This application is a continuation of, and claims priority to and the benefit of, U.S. Application No Ser. No. 17/744,542, filed May 13, 2022 and entitled “ROTATING DETONATION TURBINE INTERBURNER,” which claims priority to, and the benefit of, U.S. Provisional Application No. 63/197,240 filed on Jun. 4, 2021 and titled “ROTATING DETONATION TURBINE INTERBURNER,” which are both incorporated by reference herein in their entirety for all purposes.

### FIELD

The present disclosure relates generally to gas turbine engines and, more particularly, to gas turbine engines having a supplemental combustor disposed within the turbine section of the gas turbine engine.

### BACKGROUND

Gas turbine engines typically include a fan section, a compressor section, a combustor section and a turbine section. The fan section drives air along a bypass flow path while the compressor section drives air along a core flow path. In general, during operation, air is pressurized in the compressor section and is mixed with fuel and burned in the combustor section to generate hot combustion gases. Efficient and thorough mixing and combustion of the fuel and air is often facilitated using swirlers disposed upstream of a combustion zone where burning of the fuel and air occurs. Subsequent to combustion, the hot combustion gases flow through the turbine section, which extracts energy from the hot combustion gases to power the compressor section and other gas turbine engine loads, such as those required to rotate fan blades in the fan section. The compressor section typically includes low-pressure and high-pressure compressors, and the turbine section includes low-pressure and high-pressure turbines.

Typically, gas turbine engines are powered by the energy produced in combusting fuels in a single primary combustor. The energy from combustion is used to turn the turbine that drives the fan section and the compressor section to pressurize the flow entering the combustor and to produce engine thrust. A single combustor must operate over a broad range of fuel-air ratios. This may present a challenge to the combustor and the turbomachinery as they need to accommodate a broad range of operation (e.g., temperatures, pressures, rotational speeds and flow rates) from takeoff, cruise to idle. This also drives gas turbine designers to increase complexity, cost and weight to the turbomachinery to meet durability targets. The introduction of an inter-turbine burner to permit stage combustion is an attractive option to enhance engine capability and durability while overcoming some of the impacts of a single combustor engine system.

### SUMMARY

An assembly for a gas turbine engine is disclosed. In various embodiments, the assembly includes a primary combustor disposed within a core flow path of the gas turbine engine; a high-pressure turbine positioned downstream of the primary combustor; a low-pressure turbine positioned downstream of the high-pressure turbine; and a supplemental combustor positioned within the core flow path, downstream of the high-pressure turbine and upstream of the low-pressure turbine.

In various embodiments, the supplemental combustor is a rotating detonation combustor. In various embodiments, the rotating detonation combustor includes a fuel-air mixer configured to receive a compressed air and a fuel. In various embodiments, the compressed air is provided by a compressor section of the assembly. In various embodiments, the rotating detonation combustor includes an annular structure positioned downstream of the fuel-air mixer, the annular structure configured to combust the compressed air and the fuel. In various embodiments, the annular structure is configured to combust the compressed air, the fuel and an exhaust stream, the exhaust stream exiting the high-pressure turbine

In various embodiments, the assembly includes a high-speed spool and the compressor section includes a high-pressure compressor interconnected with the high-pressure turbine via the high-speed spool. In various embodiments, the assembly includes a low-speed spool and the compressor section includes a low-pressure compressor interconnected with the low-pressure turbine via the low-speed spool.

In various embodiments, a first variable vane is positioned downstream of the rotating detonation combustor and upstream of the low-pressure turbine and configured to manage a core flow pressure downstream of the rotating detonation combustor. In various embodiments, a second variable vane is positioned upstream of the rotating detonation combustor and downstream of the high-pressure turbine and configured to manage a core flow pressure upstream of the rotating detonation combustor.

A gas turbine engine, the gas turbine engine defining a core flow path, is disclosed. In various embodiments, the gas turbine engine includes a primary combustor positioned within the core flow path; a high-pressure turbine positioned downstream of the primary combustor; a low-pressure turbine positioned downstream of the high-pressure turbine; a supplemental combustor positioned within the core flow path, downstream of the high-pressure turbine and upstream of the low-pressure turbine; a high-pressure compressor positioned upstream of the primary combustor; a low-pressure compressor positioned upstream of the high-pressure compressor.

In various embodiments, the gas turbine engine includes a high-speed spool, the high-speed spool configured to interconnect the high-pressure compressor with the high-pressure turbine. In various embodiments, the gas turbine engine includes a low-speed spool, the low-speed spool configured to interconnect the low-pressure compressor with the low-pressure turbine.

In various embodiments, the supplemental combustor is a rotating detonation combustor. In various embodiments, the rotating detonation combustor includes a fuel-air mixer configured to receive a compressed air and a fuel and to generate a fuel-air mixture. In various embodiments, the compressed air is provided by the low-pressure compressor or the high-pressure compressor. In various embodiments, the rotating detonation combustor includes an annular structure positioned downstream of the fuel-air mixer and the annular structure is configured to combust the fuel-air mixture and an exhaust stream, the exhaust stream exiting the high-pressure turbine. In various embodiments, a first variable vane is positioned downstream of the rotating detonation combustor and upstream of the low-pressure turbine and a second variable vane is positioned upstream of the rotating detonation combustor and downstream of the high-pressure turbine, the first variable vane and the second variable vane configured to manage a core flow pressure downstream and upstream of the rotating detonation combustor.

A method of operating a gas turbine engine, the gas turbine engine defining a core flow path, is disclosed. In various embodiments, the method includes providing a pressurized air stream into a primary combustor positioned within the core flow path; combusting the pressurized air stream in the primary combustor to produce a high-temperature combustion exhaust; expanding the high-temperature combustion exhaust through a high-pressure turbine positioned downstream of the primary combustor to produce a high-pressure turbine exhaust; providing the high-pressure turbine exhaust to a rotating detonation compressor, the rotating detonation compressor positioned within the core flow path; combusting the high-pressure turbine exhaust with a fuel-air mixture to produce a rotating detonation combustor exhaust; and expanding the rotating detonation combustor exhaust through a low-pressure turbine.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a cross sectional schematic view of a gas turbine engine, in accordance with various embodiments;

FIGS. 2A and 2B are schematic views of a rotating detonation combustor, in accordance with various embodiments;

FIG. 3 is a cross sectional schematic view of a turbine section of a gas turbine engine having a rotating detonation combustor disposed between the high-pressure turbine and the low-pressure turbine, in accordance with various embodiments; and

FIG. 4 describes a method of operating a gas turbine engine, the gas turbine engine defining a core flow path, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

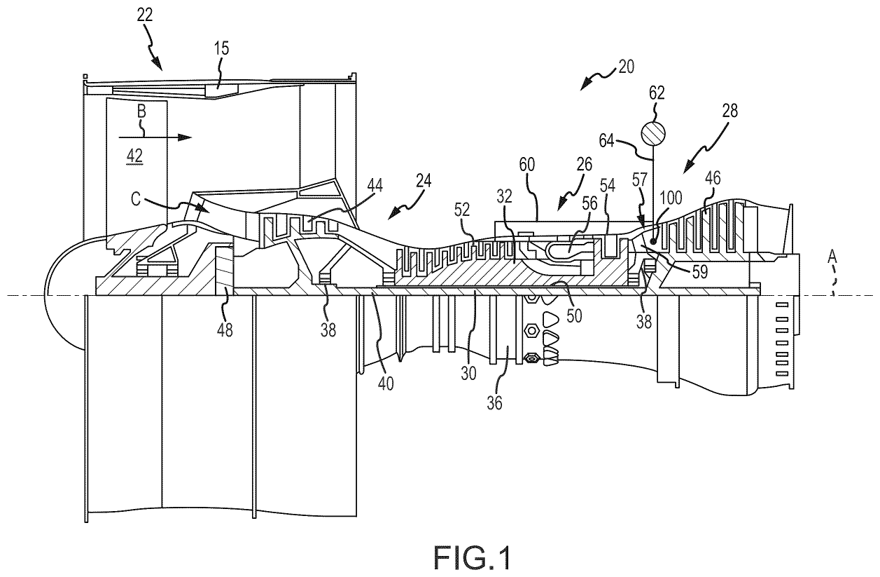

Referring now to the drawings, FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 15, while the compressor section 24 drives air along a core flow path C for compression and communication into the combustor section 26 and then expansion through the turbine section 28. Although depicted as a two-spool turbofan gas turbine engine in the disclosed non-limiting embodiment, the concepts described herein are not limited to use with two-spool turbofans as the teachings may be applied to other types of turbine engines.

The gas turbine engine 20 generally includes a low-speed spool 30 and a high-speed spool 32 mounted for rotation about an engine central longitudinal axis A relative to an engine static structure 36 via several bearing systems 38. Various bearing systems at various locations may alternatively or additionally be provided and the location of the several bearing systems 38 may be varied as appropriate to the application. The low-speed spool 30 generally includes an inner shaft 40 that interconnects a fan 42, a low-pressure compressor 44 and a low-pressure turbine 46. The inner shaft 40 is connected to the fan 42 through a speed change mechanism, which in this gas turbine engine 20 is illustrated as a fan drive gear system 48 configured to drive the fan 42 at a lower speed than that of the low-speed spool 30. The high-speed spool 32 includes an outer shaft 50 that interconnects a high-pressure compressor 52 and a high-pressure turbine 54. A combustor 56 (or a primary combustor) is arranged in the gas turbine engine 20 between the high-pressure compressor 52 and the high-pressure turbine 54. A mid-turbine frame 57 of the engine static structure 36 is arranged generally between the high-pressure turbine 54 and the low-pressure turbine 46 and may include airfoils 59 in the core flow path C for guiding the flow into the low-pressure turbine 46. The mid-turbine frame 57 further supports the several bearing systems 38 in the turbine section 28. The inner shaft 40 and the outer shaft 50 are concentric and rotate via the several bearing systems 38 about the engine central longitudinal axis A, which is collinear with longitudinal axes of the inner shaft 40 and the outer shaft 50.

The air in the core flow path C is compressed by the low-pressure compressor 44 and then the high-pressure compressor 52, mixed and burned with fuel in the combustor 56, and then expanded over the high-pressure turbine 54 and the low-pressure turbine 46. The low-pressure turbine 46 and the high-pressure turbine 54 rotationally drive, respectively, the low-speed spool 30 and the high-speed spool 32 in response to the expansion. It will be appreciated that each of the positions of the fan section 22, the compressor section 24, the combustor section 26, the turbine section 28, and the fan drive gear system 48 may be varied. For example, the fan drive gear system 48 may be located aft of the combustor section 26 or even aft of the turbine section 28, and the fan section 22 may be positioned forward or aft of the location of the fan drive gear system 48.

Still referring to FIG. 1, a supplemental combustor which, in various embodiments, may take the form of a rotating detonation combustor 100, is positioned between the low-pressure turbine 46 and the high-pressure turbine 54. In various embodiments, compressed air from the compressor section 24 is delivered to the rotating detonation combustor 100 via a compressed air duct 60 and fuel from a fuel source 62 is delivered to the rotating detonation combustor 100 via a fuel duct 64. The combustion process begins in the rotating detonation combustor 100 when the fuel-air mixture is ignited via a spark or another suitable ignition source to generate a compression wave. The compression wave is followed by a chemical reaction that transitions the compression wave to a detonation wave. The detonation wave enters a combustion chamber of the rotating detonation combustor 100 and travels along the combustion chamber. As the detonation wave consumes the air and the fuel, combustion products traveling along the combustion chamber accelerate and are discharged from the rotating detonation combustor 100, with the combustion products being used to drive the low-pressure turbine 46.

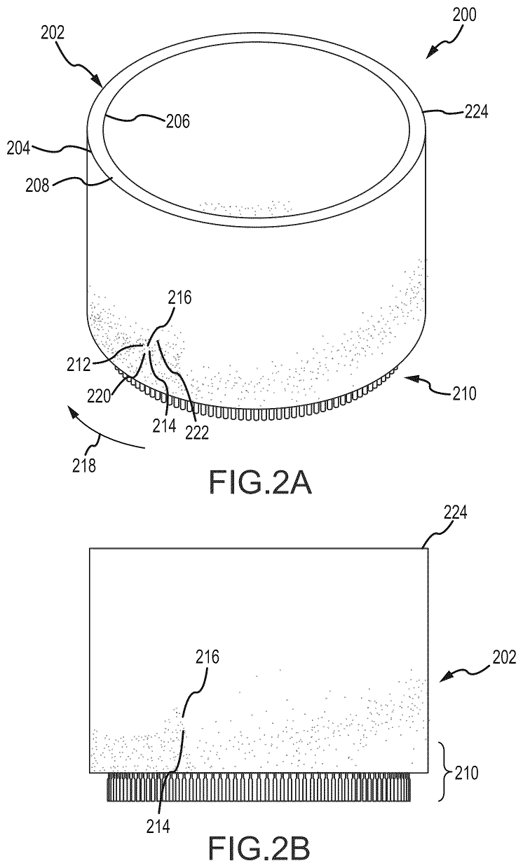

Referring now to FIGS. 2A and 2B, a rotating detonation combustor 200, similar to the rotating detonation combustor 100 described above with reference to FIG. 1, is illustrated. The rotating detonation combustor 200 may include an annular structure 202 including an outer cylinder 204 and an inner cylinder 206. The outer cylinder 204 and the inner cylinder 206 define a volume 208 therebetween. Although the rotating detonation combustor 200 is shown as an annular structure, the rotating detonation combustor 200 may have any shape that provides a continuous path for detonation to occur. For example, the rotating detonation combustor 200 may have an elliptical shape, a trapezoidal shape, or the like. In this regard, where used in this context, the term “annulus” or “annular structure” may refer to any continuous circumferential channel having an annular or any other shape such as trapezoidal, conical, or elliptical. Furthermore, where used herein, the term “annular volume” may likewise refer to any continuous circumferential channel having annular or any other shape such as trapezoidal or elliptical.

In various embodiments, a fuel-air mixer 210 is positioned upstream from the annular structure 202 and is configured to provide a fuel mixture 212 including a combustible blend of air (or oxidizer) and fuel. The combustible blend may comprise, for example, the compressed air from the compressor section 24 and the fuel from the fuel source 62 described above with reference to FIG. 1. The fuel mixture 212 may be continuously introduced into the volume 208. The rotating detonation combustor 200 is then initialized (e.g., ignited), causing a detonation wave 214 to occur. The detonation wave 214 corresponds to an ignition or combustion of the fuel mixture 212 at a particular location about a circumference of the annular structure 202. The detonation wave 214 may then continuously travel around the circumference of the annular structure 202. As shown in FIG. 2A, the detonation wave 214 may occur at a location 216 and may travel in a direction illustrated by an arrow 218. A first location 220 within the volume 208 and preceding the detonation wave 214 may include a relatively large density of the fuel mixture 212. As the detonation wave 214 reaches the first location 220, the density of the fuel mixture 212 allows the fuel mixture 212 to detonate. After detonation occurs, the fuel mixture 212 is burned away and the force of the detonation wave 214 temporarily resists entry of additional amounts of the fuel mixture 212 into the volume 208. Accordingly, a second location 222 that has recently detonated may have a relatively low density of the fuel mixture 212. As a result, the detonation wave 214 continues to rotate about the volume 208 in the direction shown by the arrow 218. The detonation wave 214 generates detonation exhaust. The rotating detonation combustor 200 includes a downstream outlet 224 through which the detonation exhaust travels prior to reaching the low-pressure turbine 46 (see FIG. 1).

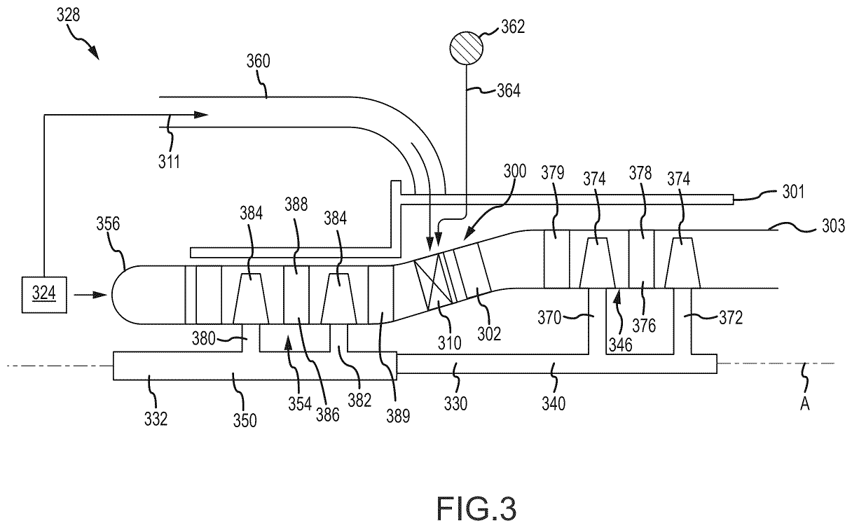

Referring now to FIG. 3, a turbine section 328 of a gas turbine engine, such as, for example, the turbine section 28 described above with reference to FIG. 1, is illustrated. The turbine section is located downstream of a combustor 356 (or a primary combustor), which itself is located downstream of a compressor section 324, such as, for example, the compressor section 24 described above with reference to FIG. 1. The turbine section 328 includes a low-speed spool 330 and a high-speed spool 332 mounted for rotation about an engine central longitudinal axis A. The low-speed spool 330 generally includes an inner shaft 340 that interconnects a low-pressure compressor, comprised within the compressor section 324, and a low-pressure turbine 346. The high-speed spool 332 includes an outer shaft 350 that interconnects a high-pressure compressor, comprised within the compressor section 324, and a high-pressure turbine 354. The combustor 356 is positioned between the high-pressure compressor, comprised within the compressor section 324, and the high-pressure turbine 354. While the disclosure references the compressor section 324 as including both a low-pressure compressor and a high-pressure compressor, it is noted the disclosure contemplates various other compressor configurations, such as, for example, a single compressor attached to one of the low-speed spool 330 or the high-speed spool 332.

In various embodiments, the low-pressure turbine 346 includes a first rotor 370 and a second rotor 372 and a plurality of rotor blades 374 attached to each of the first rotor 370 and the second rotor 372. A stator 376 having a plurality of stator vanes 378 is positioned between the first rotor 370 and the second rotor 372. In various embodiments, a first variable vane 379 (or downstream variable vane) is positioned downstream of the rotating detonation combustor 300 and upstream of the first rotor 370 of the low-pressure turbine 346. In similar fashion, the high-pressure turbine 354 includes a first rotor 380 and a second rotor 382 and a plurality of rotor blades 384 attached to each of the first rotor 380 and the second rotor 382. A stator 386 having a plurality of stator vanes 388 is positioned between the first rotor 380 and the second rotor 382. In various embodiments, a second variable vane 389 (or upstream variable vane) is positioned upstream of the rotating detonation combustor 300 and downstream of the second rotor 382 of the high-pressure turbine 354. Note that while the low-pressure turbine 346 and the high-pressure turbine 354 are each described as having a first rotor and a second rotor, the disclosure contemplates each turbine section having any number of additional rotors and pluralities of rotor blades.

Still referring to FIG. 3, a rotating detonation combustor 300 (or an inter-turbine burner), similar to the rotating detonation combustor 200 described above with reference to FIGS. 2A and 2B, is positioned between the low-pressure turbine 346 and the high-pressure turbine 354. Similar to the description above, the rotating detonation combustor 300 includes an annular structure 302 and a fuel-air mixer 310 positioned upstream from the annular structure 302. The fuel-air mixer is configured to provide a fuel mixture (e.g., the fuel mixture 212) including a combustible blend of air (or oxidizer) and fuel. The combustible blend may comprise, for example, a compressed air 311 from the compressor section 324 and a fuel from a fuel source 362, similar to operation of the gas turbine engine 20 described above with reference to FIG. 1. In various embodiments, the compressed air 311, bled from the compressor section 324, is delivered to the rotating detonation combustor 300 (or to the fuel-air mixer 310) via a compressed air duct 360 and the fuel from the fuel source 362 is delivered to the rotating detonation combustor 300 (or to the fuel-air mixer 310) via a fuel duct 364. The compressed air 311 may also be used to cool the rotating detonation combustor 300, or one or both of the low-pressure turbine 346 and the high-pressure turbine 354, by circulating the compressed air 311 between a turbine section case 301 and a core engine case 303. In various embodiments, the compressed air duct 360 may be active when the supplemental combustor (e.g., rotating combustion combustor 300) is initialized (e.g., ignited) to cool the supplemental combustor.

While the disclosure describes the rotating detonation combustor 300 as being positioned between the low-pressure turbine 346 and the high-pressure turbine 354, the disclosure contemplates other configurations. For example, in various embodiments, the rotating detonation combustor is positioned between any two adjacent turbine sections, where the upstream turbine section operates generally over a higher-pressure range than the downstream turbine section. In addition, it is noted the disclosure contemplates use of any number of rotating detonation combustors. For example, a first rotating detonation combustor may be positioned between a first turbine section and a second turbine section and a second rotating detonation combustor may be positioned between the second turbine section and a third turbine section, where such embodiment is typical of a three-spool gas turbine engine. Further, it is noted that while the disclosure describes the rotating detonation combustor 300 as receiving fuel from the fuel source 362, the fuel source 362, in various embodiments, is the same fuel source used to supply fuel to the combustor 356, though the fuel supplied to the combustor 356 and the rotating detonation combustor 300 may be metered independently (e.g., by separate fuel pumps) to stage the combustion processes in each combustor independently and to manage the thermal energy directed to the turbine section(s) located downstream of the rotating detonation combustor 300.

With continued reference to FIG. 3, during operation, air enters a gas turbine engine (e.g., the gas turbine engine 20 described above with reference to FIG. 1) and is routed through a core flow path C into the compressor section 324. The air is compressed in the compressor section 324 to produce a pressurized air stream, which is then mixed with fuel and combusted in the combustor 356 to produce a high-temperature combustion exhaust. The high-temperature combustion exhaust is then routed to the high-pressure turbine 354 where it is expanded to drive the high-speed spool 332. The high-temperature combustion exhaust that enters the high-pressure turbine 354 exits the high-pressure turbine 354 as a high-pressure turbine exhaust and is directed toward the second variable vane 389. The second variable vane 389, positioned upstream of the rotating detonation combustor 300, then redirects the high-pressure turbine exhaust, which may have a substantial swirl component, toward the fuel-air mixer 310 of the rotating detonation combustor 300. The compressed air 311 and the fuel from the fuel source 362 is then mixed with the high-pressure turbine exhaust and combusted in the annular structure 302 of the rotating detonation combustor 300, substantially as described above with reference to FIGS. 2A and 2B, to produce a rotating detonation combustor exhaust, which generally flows at a higher pressure and higher velocity than the high-pressure turbine exhaust that enters the rotating detonation combustor 300. The rotating detonation combustor exhaust that exits the rotating detonation combustor 300 then flows toward the first variable vane 379. The first variable vane 379, positioned downstream of the rotating detonation combustor 300, then redirects the rotating detonation combustor exhaust, which may have a substantial swirl component, toward the low-pressure turbine 346, where the rotating detonation combustor exhaust is expanded through the first rotor 370 and the second rotor 372 to drive the low-speed spool 330. In addition to redirecting the direction of flow, the first variable vane 379 and the second variable vane 389 are configured to manage the core flow pressure downstream and upstream, respectively, of the rotating detonation combustor 300 to prevent blowback into the compressor section 324 or into the combustor 356, which may result from a substantial increase in core flow pressure produced by the rotating detonation combustor 300. Additionally, the first variable vane 379 and the second variable vane 389 may be used primarily for flow rate and pressure control, at locations downstream and upstream of the rotating detonation combustor 300, respectively, to control the combustion process within the rotating detonation combustor 300 when active.

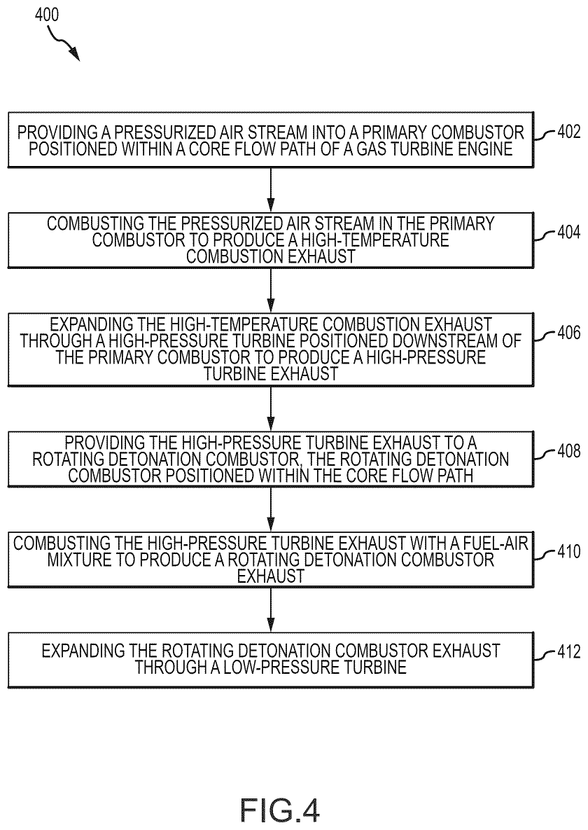

Referring now to FIG. 4, a method 400 of operating a gas turbine engine, the gas turbine engine defining a core flow path, is described in accordance with various embodiments. A first step 402 includes providing a pressurized air stream into a primary combustor positioned within the core flow path. A second step 404 includes combusting the pressurized air stream in the primary combustor to produce a high-temperature combustion exhaust. A third step 406 includes expanding the high-temperature combustion exhaust through a high-pressure turbine positioned downstream of the primary combustor to produce a high-pressure turbine exhaust. A fourth step 408 includes providing the high-pressure turbine exhaust to a rotating detonation combustor, the rotating detonation combustor positioned within the core flow path. A fifth step 410 includes combusting the high-pressure turbine exhaust with a fuel-air mixture to produce a rotating detonation combustor exhaust. A sixth step 412 includes expanding the rotating detonation combustor exhaust through a low-pressure turbine. In various embodiments, a seventh step includes managing a core flow pressure downstream and upstream of the rotating detonation combustor via a first variable vane positioned downstream of the rotating detonation combustor and upstream of the high-pressure turbine and a second variable vane positioned upstream of the rotating detonation combustor and downstream of the high-pressure compressor.

The foregoing disclosure defines a gas turbine engine architecture that deploys a rotating detonation combustor as an inter-turbine burner configuration for turbofan, turbojet or turboshaft engine applications. The engine architecture involves a primary combustor in the core flow path that powers the high-pressure turbine and the high-pressure compressor as found in contemporary gas turbine engines. A supplemental combustor, in the form of a rotating detonation combustor, is positioned between the high-pressure turbine and the low-pressure turbine sections of the engine. The configuration described above specifically leverages rotating detonation combustion as the means of combustion for the inter-turbine burner. The invention involves a transition section downstream of the high-pressure turbine that collects the core flow and accelerates it towards a fuel-air mixer (e.g., a swirler section) that orients the flow to contribute angular motion of the flow into an annular structure (e.g., a supplemental combustion section) where fuel or fuel-air mixtures are introduced into the core flow. The inter-turbine burner configuration, in various embodiments, includes a variable vane (or a variable strut), positioned upstream or downstream (or both upstream and downstream) of the supplemental combustor, that is used to promote back pressure to mitigate reverse flow or blowback flow during operation of the supplemental combustor. In various embodiments, there may be variable blades or other variable area and/or flow control devices in addition the variable vain (or variable strut). The supplemental combustor section may be cooled and fed by bleed air from the compressor section. An inter-turbine burner may also be positioned downstream between additional turbine sections, including forward of a power turbine in a turboshaft application. Various benefits of the disclosure include an inter-turbine burner configuration that provides operational flexibility of gas turbine engines to optimize performance, emissions, durability, ignition, stability, axial length and weight. Introduction of the inter-turbine burner configuration may introduce parasitic losses and pressure drop but a supplemental combustor in the form of a rotating detonation combustor may provide an increase in core flow pressure that offsets these losses and increases the pressure of the core flow entering the low-pressure turbine for improved performance. A rotating detonation combustor may also present a compact design that is relatively simple to deploy in machined castings or other types of fabrication.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, system program instructions or controller instructions may be loaded onto a tangible, non-transitory, computer-readable medium (also referred to herein as a tangible, non-transitory, memory) having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media that were found by In Re Nuijten to fall outside the scope of patentable subject matter under 35 U.S.C. § 101.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

Finally, any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. An assembly for a gas turbine engine, comprising:
a primary combustor disposed within a core flow path of the gas turbine engine;
a high-pressure turbine positioned downstream of the primary combustor;
a low-pressure turbine positioned downstream of the high-pressure turbine; and
a supplemental combustor positioned within the core flow path, downstream of the high-pressure turbine and upstream of the low-pressure turbine.

2. The assembly of claim 1, wherein the supplemental combustor is a rotating detonation combustor.

3. The assembly of claim 2, wherein the rotating detonation combustor includes a fuel-air mixer configured to receive a compressed air and a fuel.

4. The assembly of claim 3, further comprising a compressor section and wherein the compressed air is provided by the compressor section.

5. The assembly of claim 4, wherein the rotating detonation combustor includes an annular structure positioned downstream of the fuel-air mixer.

6. The assembly of claim 5, wherein the annular structure is configured to combust the compressed air and the fuel.

7. The assembly of claim 6, wherein the annular structure is configured to combust the compressed air, the fuel and an exhaust stream, the exhaust stream exiting the high-pressure turbine.

8. The assembly of claim 7, further comprising a high-speed spool and wherein the compressor section includes a high-pressure compressor interconnected with the high-pressure turbine via the high-speed spool.

9. The assembly of claim 8, further comprising a low-speed spool and wherein the compressor section includes a low-pressure compressor interconnected with the low-pressure turbine via the low-speed spool.

10. The assembly of claim 9, further comprising a first variable vane positioned downstream of the rotating detonation combustor and upstream of the low-pressure turbine and configured to manage a core flow pressure downstream of the rotating detonation combustor.

11. The assembly of claim 9, further comprising a second variable vane positioned upstream of the rotating detonation combustor and downstream of the high-pressure turbine and configured to manage a core flow pressure upstream of the rotating detonation combustor.

12. A gas turbine engine, the gas turbine engine defining a core flow path, comprising:
a primary combustor positioned within the core flow path;
a high-pressure turbine positioned downstream of the primary combustor;
a low-pressure turbine positioned downstream of the high-pressure turbine;
a supplemental combustor positioned within the core flow path, downstream of the high-pressure turbine and upstream of the low-pressure turbine;
a high-pressure compressor positioned upstream of the primary combustor; and
a low-pressure compressor positioned upstream of the high-pressure compressor.

13. The gas turbine engine of claim 12, further comprising a high-speed spool, the high-speed spool configured to interconnect the high-pressure compressor with the high-pressure turbine.

14. The gas turbine engine of claim 13, further comprising a low-speed spool, the low-speed spool configured to interconnect the low-pressure compressor with the low-pressure turbine.

15. The gas turbine engine of claim 14, wherein the supplemental combustor is a rotating detonation combustor.

16. The gas turbine engine of claim 15, wherein the rotating detonation combustor includes a fuel-air mixer configured to receive a compressed air and a fuel and to generate a fuel-air mixture.

17. The gas turbine engine of claim 16, wherein the compressed air is provided by the low-pressure compressor or the high-pressure compressor.

18. The gas turbine engine of claim 17, wherein the rotating detonation combustor includes an annular structure positioned downstream of the fuel-air mixer and the annular structure is configured to combust the fuel-air mixture and an exhaust stream, the exhaust stream exiting the high-pressure turbine.

19. The gas turbine engine of claim 18, further comprising a first variable vane positioned downstream of the rotating detonation combustor and upstream of the low-pressure turbine and a second variable vane positioned upstream of the rotating detonation combustor and downstream of the high-pressure turbine, the first variable vane and the second variable vane configured to manage a core flow pressure downstream and upstream of the rotating detonation combustor.

20. A method of operating a gas turbine engine, the gas turbine engine defining a core flow path, comprising:
providing a pressurized air stream into a primary combustor positioned within the core flow path;
combusting the pressurized air stream in the primary combustor to produce a high-temperature combustion exhaust;
expanding the high-temperature combustion exhaust through a high-pressure turbine positioned downstream of the primary combustor to produce a high-pressure turbine exhaust;
providing the high-pressure turbine exhaust to a rotating detonation compressor, the rotating detonation compressor positioned within the core flow path;
combusting the high-pressure turbine exhaust with a fuel-air mixture to produce a rotating detonation combustor exhaust; and
expanding the rotating detonation combustor exhaust through a low-pressure turbine.
